(19) United States
(12) Patent Application Publication
(10) Pub. No.: US 2014/0136438 A1
(43) Pub. Date: May 15, 2014

(54) SYSTEMS AND METHODS OF OBTAINING CANDIDATE QUALIFICATIONS USING SELF-RANKING TESTING TOOLS

(71) Applicants: Scott Lee Barnett, Boston, MA (US); Jon D. Cameron, Dallas, TX (US); Carlos Francisco Skerthcly, Farmers Branch, TX (US)

(72) Inventors: Scott Lee Barnett, Boston, MA (US); Jon D. Cameron, Dallas, TX (US); Carlos Francisco Skerthcly, Farmers Branch, TX (US)

(21) Appl. No.: 13/953,297

(22) Filed: Jul. 29, 2013

Related U.S. Application Data
(60) Provisional application No. 61/794,112, filed on Mar. 15, 2013.

(51) Int. Cl. G06Q 10/10

(52) U.S. Cl. CPC G06Q 10/1053
USPC 705/321

(57) ABSTRACT

Systems and methods of attracting highly qualified candidates to a recruiter network are provided. The recruiter network may offer success-based measurement tools to potential candidates that may allow candidates to benchmark their individual career successes against their peers. The resulting test data may be quantitatively matched to recruiter profiles to identify and evaluate potential candidates that may meet specific success criteria.

### CROSS-REFERENCE TO RELATED APPLICATION

The present Application claims the benefit of U.S. Provisional Application No. 61/794,112 entitled “Obtaining Candidate Qualifications Using Self-Ranking Testing Tools,” filed Mar. 15, 2013, the disclosure of which is hereby incorporated by reference in its entirety.

### FIELD OF THE DISCLOSURE

The present disclosure generally relates to candidate recruitment, and more particularly to systems and methods of attracting candidates to participate in a recruiter network.

### BACKGROUND

### Traditional Personal Recruiting

Before the advent of the Internet, recruiting was done through personal recruiting where recruiters and employers would connect with individual candidates one at a time. Even since the Internet has become a widely used recruitment tool, recruiters have continued to make contact with candidates directly via phone and email. The relationships formed between recruiters and candidates may be developed over time and may even begin before the candidates are even interested in securing new employment. The advantages of traditional personal recruiting included (1) recruiters had ready access to qualified candidates; (2) recruiters could build relationships with passive candidates who would eventually be interested in another job but were not actively looking; (3) employers could get in touch with candidates that were more likely to be passive candidates for larger portions of their careers, which employers may consider to be more valuable candidates; (4) recruiters could create a detailed understanding of the candidates' respective capabilities and needs; (5) recruiters were enabled to convince candidates to consider job opportunities that they otherwise might not have considered; (6) recruiters could coach candidates through the interview process, giving the candidates better opportunities to land the job; (7) recruiters could get feedback from employers on each candidate and then share that feedback in a constructive manner with candidates; (8) recruiters could target candidates with specific knowledge, skills, abilities, or other attributes; and (9) recruiters could target candidates within a specific geographic area, thereby minimizing costs associated with interviewing and hiring candidates.

Traditional recruiting models were ripe for modernization as employers began to look for ways to connect with large groups of qualified candidates, reduce their costs to hire, and streamline their own assessment/interview processes. Additionally, candidates began to look for ways to learn about additional relevant job opportunities and minimize the amount of time required for them to apply for a job. Today, one-on-one personal recruiting is still largely used with respect to senior executive positions and in-demand professions, but the Internet has become a tool that most tend to utilize when looking for job opportunities. This has caused some candidates to circumvent the benefits of using a recruiter when seeking employment. One-on-one personal recruiting systems still come up short in recruiting needs. Complaints include: (1) lack of access to a larger group of qualified candidates; (2) difficulty in receiving candidate buy-in to work with a specific recruiter because candidates tend to guard information until the recruiter provides valuable information in return, but the recruiter lacks personalized feedback to provide that information; (3) time needed to reach out to new candidates; (4) time needed to assess candidates for knowledge, skills, abilities, or other attributes that make them attractive to an employer; (5) time needed to follow up with candidates that the recruiter does not want to represent; (6) difficulty for recruiters to locate very specific knowledge, skills, abilities, and other attributes that are less in demand and more difficult to place; (7) challenges in building relationships between recruiters and candidates who prefer on-line communication to personal conversations; and (8) difficulty for recruiters to locate candidates who are largely satisfied with their jobs and focused on their work.

### Job Postings

The use of employer, or recruiter, printed advertising has been prevalent for a long time. Before the 1990s, local candidates were commonly reached through regional newspapers. National candidates, as high as Chief Executive Officers, were reached through national newspapers like the Wall Street Journal and USA Today. These printed advertisements provided advantages including (1) enabling recruiters and employers to create awareness among a large number of candidates; (2) allowing recruiters and employers to create awareness of specific opportunities among passive job candidates who were not actively looking for opportunities; (3) enabling recruiters and employers to reduce the cost of getting in touch with candidates; (4) giving candidates the ability to more quickly consider opportunities by reading a job description as opposed to conversing with a recruiter; (5) enabling candidates to better research the market demand for different knowledge, skills, abilities, and other attributes; (6) allowing employers to advertise the opportunity as opposed to relying on recruiters who were expensive and who might, at times, distort the message; and (7) giving candidates the ability to understand what companies are hiring and what specific openings are available to be filled.

At the same time, printed advertising provided many pain points for employers and candidates alike including, (1) limiting employers to advertising for publicly known positions, thereby preventing employers from advertising for a replacement for a planned termination; (2) limiting employers' ability to fully explain the requirements of the position; (3) difficulty in attracting candidates who were not actively looking for a new job and the likelihood of attracting candidates that were less appealing than those who are mostly satisfied with their jobs and busy at work; (4) receiving applications from many candidates not qualified for the job opening, making the process more time consuming and costly; (5) reluctance to post positions that employers do not want their competition to know are vacant; (6) difficulty for candidates to know whether an employer or recruiter has taken down a job posting that has already been filled; (7) difficulty for candidates to demonstrate their knowledge, skills, abilities, and other attributes through a resume and cover letter, thereby proving that they are, in fact, highly qualified; and (8) candidates' fear of their current employers finding out that they have applied for other positions.

Job postings have moved online as the adoption of personal computers has become more commonplace. Initially, the first online efforts with job postings largely mirrored their physical world counterparts, with job postings listed in online classifieds. Then, companies such as monster.com, created job boards where employers could list jobs and candidates could search through them based on location and other keywords. As the Internet has continued to evolve, the technologies supporting it have become more robust, and new approaches and business models related to e-recruiting have begun to proliferate.

### E-Recruitment

E-recruitment is a modern system whereby employers and candidates are able to utilize technology and the Internet to learn about job opportunities, identify qualified candidates, and connect employers with candidates. E-recruitment had the immediate benefits of: (1) enabling employers to reach a large audience of candidates in a cost effective manner; (2) allowing employers to create a brand within the recruiting market to attract and retain specific types of candidates; (3) making it easier for candidates to search for jobs that fit their skill sets and interests; and (4) making it relatively simply for candidates to apply for jobs using pre-stored profiles.

E-recruitment websites may vary in their content and purpose but the most typical configuration is that of a job board. Established job boards like monster.com and CareerBuilder remain popular. Additionally, it is estimated there are over 100,000 niche job boards on the Internet targeting geographic-specific markets or niche markets related to a specific industry, profession, or skill set. Other types of solutions exist as well, including: job aggregation companies, like Indeed and SimplyHired, that aggregate job posts from thousands of websites and organize them onto a single, searchable website. Job matching companies, like JobFox and TheLadders, match candidates with jobs or job profile using keyword matching. Social networking companies, like LinkedIn and Facebook, enable employers to look at candidate online profiles and directly initiate contact with the candidates. Despite the success of e-recruiting, these systems have their drawbacks and disadvantages, including: (1) employers receive mostly unqualified applicants for each job posting (where some estimates suggest unqualified applicants are as much as 100× more frequent that qualified applicants); (2) employers and recruiters still have difficulty reaching passive job candidates who are not actively looking for another job; (3) employers and recruiters still have trouble finding enough qualified applicants for in-demand professions and those possessing niche skills; (4) using keyword searches, employers and recruiters are typically limited in whom they can locate; qualified candidates are typically limited in their ability to find jobs based on standardized keyword searches, making it difficult to find jobs fitting their specific requirements; (6) qualified candidates often do not know whether an employer or recruiter has not taken down a job posting that has already been filled; and (7) qualified candidates often find it difficult to demonstrate their knowledge, skills, abilities, and other attributes with a standardized resume and cover letter. This makes it difficult for them to highlight individual strengths and qualified applicants are often overlooked when applying for jobs.

### SUMMARY

Embodiments of the present disclosure may comprise a method for recruiting a candidate to a recruiter network over a communications network, wherein the method provides for receiving a candidate profession identification from the candidate, transmitting an aptitude test in response to the candidate profession identification to be displayed via the candidate's browser, storing the results of the aptitude test in one or more databases residing on the recruiter network, retrieving a population of candidates associated with the candidate profession identification from the one or more databases, using at least one processor, comparing the results of the aptitude test to the population to form a candidate profile, storing the candidate profile in the one or more databases, and in response to criteria provided by a recruiter, providing one or more candidate profiles to the recruiter. The method also may further comprise evaluating whether the population is sufficient from which to perform the comparing step and generate a benchmark report comparing the candidate against the population of candidates associated with the candidate profession identification. The method may further comprise providing the benchmark report comparing the candidate against the population of candidates associated with the candidate profession identification. In some embodiments of the present disclosure, the method also may comprise, via the candidate's browser, displaying a promise to the candidate to provide the benchmark report to the candidate when the population of candidates associated with the candidate profession identification is sufficient from which to perform the comparing step. Further, in some embodiments of the present disclosure, when the benchmark report is displayed to the candidate, a notification may be displayed to the candidate that the promise has been fulfilled. The aptitude test may request the following information, including, candidate name, and one or more items of information that are specifically associated with the candidate's current profession, including but not necessarily limited to identification of current profession and years in current profession. Further, it should be appreciated that candidate name may include the candidate's actual name, identifying information associated with the candidate (i.e., social security number, home address), the candidate's online identity (i.e., e-mail address, Facebook login, Twitter login, LinkedIn login), or a combination thereof The method also may comprise receiving additional information from the candidate to form part of the candidate profile.

Other embodiments of the present disclosure may provide a method for recruiting a candidate to a recruiter network over a communications network, the method comprising, using a browser, providing a candidate profession identification, in response to providing the candidate profession identification, completing an aptitude test, and receiving a benchmark report comparing the results of the aptitude test to a population of candidates associated with the candidate profession identification, the benchmark report providing a real time ranking of the candidate relative to the population of candidates associated with the candidate profession identification based on the results of the aptitude test. The method also may comprise when the population of candidates associated with the candidate profession identification is insufficient to provide a benchmark report to the candidate, receiving a promise to be provided the benchmark report when the population of candidates associated with the candidate profession identification is sufficient from which to provide a real time ranking of the candidate. In some embodiments of the present disclosure, the method may further comprise when the benchmark report is displayed following receipt of the promise, receiving a notification that the promise has been fulfilled. The method also may comprise completing more than one aptitude test, wherein each of aptitude tests is associated with the candidate profession identification. The results of the aptitude test may become part of the population of candidates associated with the candidate profession identification.

Additional embodiments of the present disclosure may provide a computer-implemented recruiter network, the network comprising, at least one database that may store aptitude test data received from one or more candidates forming a population of candidates associated with a candidate profession identification, and at least one processor that may comprise the aptitude test data received from a candidate against the population of candidates associated with the candidate profession identification to form a candidate profile, wherein the recruiter network may communicate with candidates and recruiters over at least one communication network. The recruiter network may communicate with a candidate browser over the at least one communication network. The candidate browser may utilize one or more items selected from the group comprising, HTML/CSS, Javascript, Ajax, email, CRM, and downloadable assets. The recruiter network also may include a recruiter social networking tool for recruiters and candidates. The recruiter network may further comprise an application layer containing at least aptitude tests, reports, and a metrics manager. The recruiter network also may be comprised of a services layer containing at least candidate management tools, analytics, and business logic, wherein the services layer communicates with a database access layer for database interface and caching. The at least one processor may generate a benchmark report that may be displayed on the candidate browser, the benchmark report based on the comparison of the candidate's aptitude test data with the population. The at least one processor may generate a promise notification that may be displayed on the candidate browser when the population of candidates associated with the candidate profession identification is insufficient from which to compare the candidate's aptitude test data.

### BRIEF DESCRIPTION OF THE DRAWINGS

For a more complete understanding of this disclosure, reference is now made to the following description, taken in conjunction with the accompanying drawings, in which:

FIG. 1 is a flow chart depicting collecting, evaluating and benchmark reporting for a candidate in a recruiter network according to an embodiment of the present disclosure;

FIG. 2A is a flow chart depicting a process of obtaining qualified candidates to join a recruiter network using self-ranking testing tools according to an embodiment of the present disclosure;

FIG. 2B is a flow chart depicting a recruiter process of searching for qualified candidates from the recruiter network according to an embodiment of the present disclosure;

FIG. 3 depicts different input and output scenarios for candidates and recruiters according to an embodiment of the present disclosure;

FIG. 4 is a flow chart depicting a system involving two candidates presented with three aptitude tests that may be matched to one recruiter profile according to an embodiment of the present disclosure;

FIG. 5 is a flow chart depicting a system combining the candidate benchmarking process with inputs to a recruiter database according to an embodiment of the present disclosure; and

FIG. 6 depicts layers of a system combining the candidate benchmarking process with aspects of a recruiter database according to an embodiment of the present disclosure.

### DETAILED DESCRIPTION

Embodiments of the present disclosure are directed to systems and methods for acquiring high-quality employment candidates into a recruiter network. Such systems and methods may offer free or low-priced benchmarking tools that may reward potential candidates with graphics-based representations of their relative rankings among their peers (i.e., benchmark reports). Systems and methods according to embodiments of the present disclosure may collect this performance-based test data from a candidate through a survey or aptitude test created, at least in part, based on recruiter or employer needs, to form a candidate profile, and utilizing this candidate profile, recruitment of top-ranking candidates for a given profession may be achieved.

Systems and methods according to embodiments of the present disclosure also may provide means to identify passive job candidates through the candidate's participation in career benchmarking A benchmark report may be generated for the candidate by comparing the results of the candidate's aptitude test in real time with a population of other candidates related to a given profession. In one respect, the benchmark report may act as an incentive for the candidate to seek new opportunities either by seeking out available positions or by improving his/her skills relative to the population to become more appealing for recruiters and/or employers. It should be appreciated that when a candidate is provided a real-time ranking, the real-time ranking may in some respects be based on historical data insofar as in some embodiments of the present disclosure a somewhat non-real time ranking (i.e., using data that is one day old, one week old, or one month old, may still be helpful to a candidate. The recruiting network then may become the first point of contact for the new candidates. Systems and methods according to embodiments of the present disclosure also may provide means for creating goodwill for the recruiter network by providing candidates with this unique career benchmarking. By receiving a tailored real-time benchmark report in response to taking an aptitude test, candidates may then have an incentive to invite peers to participate in career benchmarking through systems and methods according to embodiments of the present disclosure, which then may have the potential to further expand the recruiter network. The recruiter network according to embodiments of the present disclosure may attract a larger base of high-quality candidates because many of the best candidates will be enticed to more proactively manage their career advancement through tools like benchmarking and skills evaluation. Systems and methods according to embodiments of the present disclosure may utilize quantitative and structured successes measurement to qualify candidates through the recruiter network, thereby better matching candidates with recruiters. Such systems and methods also may enable a system to attract candidates to recruiter network without having to also have a large number of employers posting jobs within the network (i.e., solving the chicken and the egg problem associated with employment and recruiter networks). These systems and methods also may attract employers and recruiters because the candidate benchmarking through the recruiter network may create a larger and more targeted audience of qualified candidates from which recruiters, and by extension, employers may select.

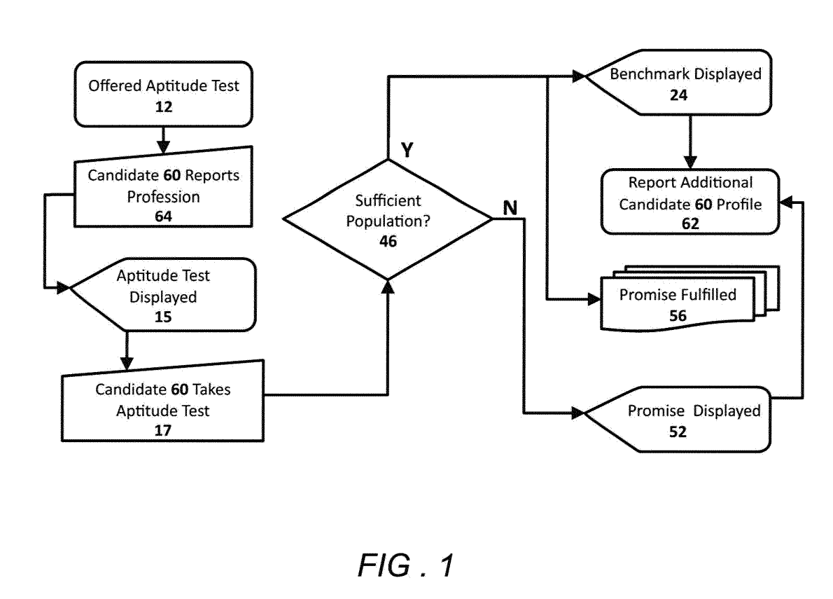

FIG. 1 is a flow chart depicting collection, evaluation and benchmark reporting of a candidate in a recruiter network according to an embodiment of the present disclosure. This flow chart depicts collection and evaluation of a candidate's experience in a given or desired profession through interacting with a recruiter network. By collecting and evaluating the results of a candidate's aptitude test in real time with respect to a similarly situated population of candidates, a candidate's own career performance may be benchmarked.

Unrelated to a job search, candidate 60 may be offered the opportunity to take an aptitude test in step 12. Before taking the aptitude test in step 17, candidate 60 may report his/her profession 64, and in response to such reporting, the aptitude test may be displayed in step 15. When candidate 60 completes taking the aptitude test in step 17, through one or more processors operating through a server network, the system may process and evaluate in real-time the statistical significance of the population (i.e., determine whether the data is sufficient from which to evaluate candidate 60 with respect to a population of similarly situated candidates) in step 46.

If the population is deemed to be sufficient in step 46, a benchmark report may be displayed by the system to candidate 60 in step 24. The benchmark report may provide the candidate with a more real-time evaluation of how he/she compares to others within the specified profession. This may assist the candidate in evaluating his/her prospects for advancement and other opportunities within the field. This may occur, for example, when a candidate ranks high in the profession based on his/her aptitude test. As a result, the candidate may become more incentivized to look for new opportunities within the field.

If the population from which to evaluate candidate 60 is deemed to be insufficient in step 46, a promise may be transmitted from the system over a communication network, such as the Internet, and displayed to candidate 60 in step 52. This promise may be a notification that a benchmark may be provided at a later determined time. The details included as part of such a promise may vary without departing from the present disclosure.

In an embodiment of the present disclosure, if after having displayed a promise to the candidate via his/her browser in step 52, the system later determines that the population is sufficient, a benchmark report may be transmitted and displayed to candidate 60 as depicted in step 24. Upon displaying the benchmark report in step 24, candidate 60 may be provided with a notification confirming that a prior promise (such as was made in step 52) made has been fulfilled in step 56.

Regardless whether a promise is displayed in step 52 or a benchmark report is displayed in step 24, candidate 60 may be provided with an opportunity to report additional information for his/her profile in step 62. This information may include other items that may generally form part of a resume or CV and that may be of interest to a potential recruiter or employer. The additional information may include but is not limited to prior experience in the field, education background, and specific skills relevant to the profession. Other items may be reported without departing from the present disclosure.

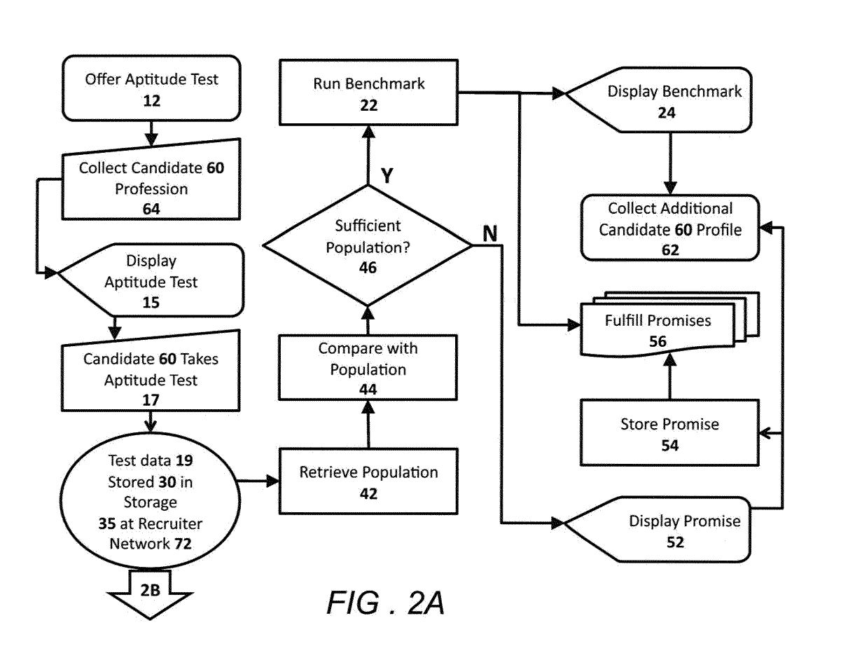

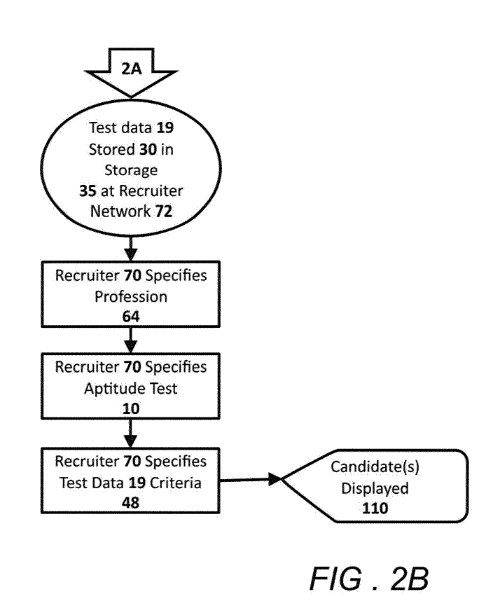

FIG. 2A is a flow chart depicting a process of obtaining qualified candidates to join a recruiter network using self-ranking testing tools according to an embodiment of the present disclosure. More specifically, FIG. 2A depicts the business and system processes originating with the offering of an aptitude test to a candidate to the point of displaying or other providing (such as by emailing) a benchmark report to a candidate. Similar to that described in FIG. 1, unrelated to a job search, candidate 60 may be offered the opportunity to take an aptitude test in step 12. Before taking the aptitude test in step 17, candidate 60 may report his/her profession 64 to the system, and in response to such reporting, one or more aptitude tests associated with the specified profession may be displayed in step 15. It should be appreciated that a candidate may be provided with more than one aptitude test to select from without departing from the present disclosure. For example, different recruiters related to particular profession may provide different aptitude tests. It also should be appreciated that in some embodiments of the present disclosure, the candidate may be offered one or more aptitude tests before he/she reports his/her profession to the system.

When candidate 60 completes an aptitude test in step 17, test data 19 compiled from processing the results of the aptitude test may be stored in one or more databases 35 within recruiter network 72. The system may then process and evaluate what has been stored in step 30 and retrieve the population from which candidate 60 may be evaluated in step 42. The system may compare candidate 60 with the population relevant to the candidate's selected profession in step 44. More specifically, the system may evaluate the statistical significance of the population (i.e., determine whether the data is sufficient from which to evaluate candidate 60 with respect to the relevant population) in step 46. If the population is deemed to be sufficient in step 46, a benchmark report may be run in step 22 and the benchmark report may be transmitted by the system and displayed to candidate 60 in step 24. If the population from which to evaluate candidate 60 is deemed to be insufficient in step 46, a promise may be displayed to candidate 60 in step 52 to provide a benchmark at a later determined time. The promise made may be stored in one or more databases in step 54. In an embodiment of the present disclosure, if after having displayed a promise in step 52, the system later determines that the population is sufficient, a benchmark report may be transmitted over a communication network, such as the Internet, and displayed to candidate 60, such as on his/her browser, as depicted in step 24. Upon displaying the benchmark report in step 24, candidate 60 may be provided with a notification that a prior promise made has been fulfilled in step 56. For example, retrieving the promise stored in one or more databases in step 54 may fulfill the prior promise. Regardless whether a promise is displayed in step 52 or a benchmark report is displayed in step 24, candidate 60 may be provided with an opportunity to report additional information for his/her profile in step 62 as was described with respect to FIG. 1.

FIG. 2B is a flow chart depicting a recruiter process of searching for qualified candidates using the recruiter network according to an embodiment of the present disclosure. A recruiter or employer may utilize test data that is supplied for benchmarking to then find potential candidates. As depicted in FIG. 2A, when candidate 60 completes the aptitude test test data 19 may be stored 30 in one or more databases 35 within recruiter network 72. Using the one or more databases 35 within recruiter network 72, recruiter 70 may specify a profession in step 64. Recruiter 70 then may specify an aptitude test in step 10. In step 48, recruiter 70 may specify test data criteria 19. Test data criteria 19 may be specified by the recruiter, may be set to defaults, or the recruiter may be provided menus of options from which to select according to embodiments of the present disclosure. Test data criteria 19 may include but is not limited to years of experience, education, particular skills, and other items of information specific to a profession that may have been requested on one or more aptitude tests. Utilizing the specified profession, aptitude test, and test data criteria from steps 64, 10, and 48, one or more candidate profiles may be displayed in step 110.

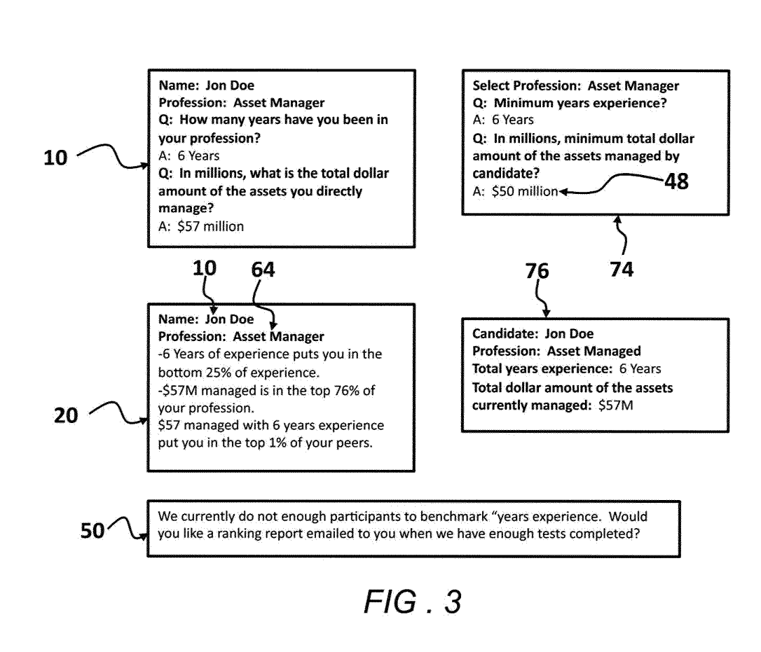

FIG. 3 depicts different input and output scenarios for candidates and recruiters according to an embodiment of the present disclosure. Aptitude test 10 depicts information that a candidate may be prompted to input into the system through completion of an aptitude or self-assessment test. This information may include, but is not limited to, name, current profession, years in current profession, and one or more items of information specific to the profession (i.e., total dollar amount of the assets managed by the candidate if he/she is in a financial management profession). When referring to aptitude, it should be appreciated that aptitude may also include compensation or income insofar as there may be a connection between income and aptitude.

Upon completion of an aptitude test, if there is a sufficient population from which to compare the candidate, a benchmark report may be transmitted by the system and displayed to the candidate. Benchmark report 20 may provide a candidate with real-time information about how he/she ranks with respect to other candidates within a specified profession. Benchmark report 20, as depicted in FIG. 3, includes the name and profession identified by the candidate in aptitude test 10 (and/or through step 64 depicted in FIG. 1). However, benchmark report 20 also provides metrics to the candidate showing how he/she ranks based on years of experience in the profession as well as how he/she ranks with respect to the items of information provided in the aptitude test that may be specific to his/her profession. In this embodiment, a candidate may be provided information on the benchmark report about how he ranks when comparing the total dollar amount of assets that he manages and his total number of years of experience in the profession against other similarly situated individuals. Accordingly, the candidate may receive, in real-time, an assessment of his/her potential for advancement as it relates to the specified profession. This may serve the purpose of motivating the candidate to pursue new opportunities or refine his/her skills to improve his/her ranking with respect to peers in the same profession according to embodiments of the present disclosure.

Recruiter profile 74 depicts information (or test data criteria 48) that a recruiter may be asked to input into the system in order for the system to collect, process, and analyze data about potential candidates. This information may include, but is not limited to, a profession, minimum years experience in the profession as well as one or more specific items of information that may be helpful to analyze related to the profession and the potential job opening. In this embodiment, the recruiter may request information about the minimum total dollar amount of the assets managed by the candidate as this may be of importance to potential employers seeking candidates with respect to the selected profession. In some embodiments of the present disclosure, the recruiter profile may include more or fewer questions than are identified in profile 74. A comparison of recruiter profile 74 to aptitude test 10 demonstrates that the candidate is being requested to provide information when completing the aptitude test that matches with the information requested in the recruiter profile. When a candidate completes aptitude test 10 and the data is processed and evaluated, the recruiter may be provided with candidate profile 76 that may include each of the items of information provided by the candidate in aptitude test 10. It should be appreciated that a recruiter may request fewer items of information be provided through candidate profile 76 than were requested via aptitude test 10 without departing from the present disclosure. This may be achieved, for example, through a narrowing query of the one or more databases within the system that may store information collected related to candidates according to embodiments of the present disclosure.

FIG. 3 also depicts an example of promise 50 that may be transmitted by the system and displayed to a candidate when the population is insufficient for benchmark report 20 to be provided to the candidate (i.e., the system is waiting for the relevant population of data to increase before a benchmark report may be generated by the system). In this embodiment, the candidate is informed through promise 50 that the system does not presently have information about enough candidates to generate and provide a benchmark report as to how the candidate ranks on “years of experience.” However, the candidate is provided with an opportunity to opt in and receive a benchmark report when enough aptitude tests have been completed from which a comparison of the candidate may be made. It should be appreciated that, in some embodiments of the present disclosure, a candidate may be provided with a benchmark report containing rankings for less than all questions included on an aptitude test without departing from the present disclosure. It also should be appreciated that promise 50 may or may not include an option for the candidate to provide a response as to whether he/she wishes to receive a benchmark report at a later time. In some embodiments of the present disclosure, the candidate may be informed that he/she will receive a benchmark report unless he/she opts out of receiving the report. In other embodiments of the present disclosure, a candidate may have to specifically request a benchmark report after receiving a promise.

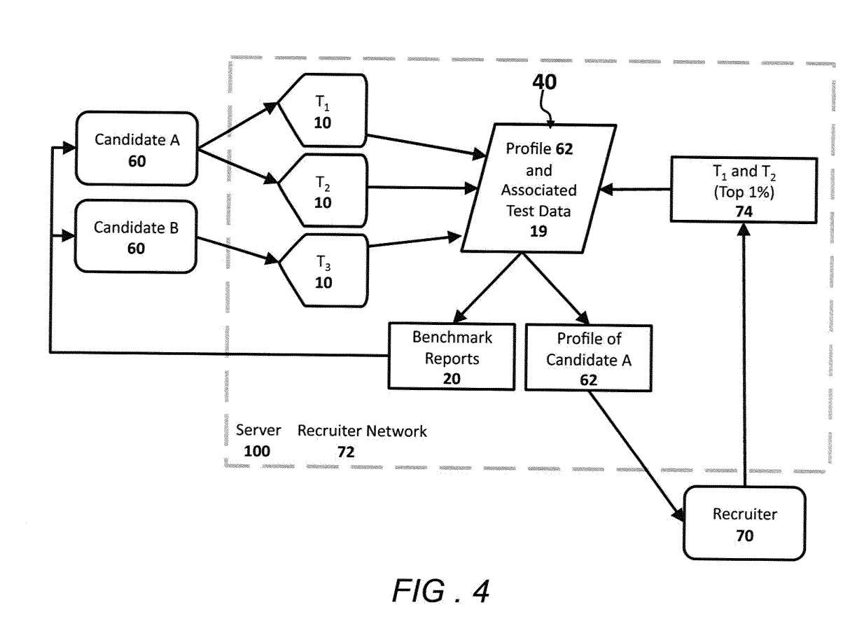

FIG. 4 is a flow chart depicting a system involving two candidates 60 (Candidate A and Candidate B) presented with three aptitude tests 10 (T₁, T₂ and T₃) that may be matched to one recruiter profile according to an embodiment of the present disclosure. In this embodiment of the present disclosure, Candidate A may elect to take two aptitude tests 10 (T₁ and T₂) while Candidate B may elect to take only one aptitude test 10 (T₃). Test data 19 compiled from each of the three aptitude tests as well as candidate profiles 62 for each of the two candidates may become part of population 40 stored within one or more databases residing on one or more servers 100 in recruiter network 72 according to embodiments of the present disclosure. Benchmark reports 20 may be generated based upon an evaluation and processing of the data contained in population 40 and provided to Candidate A and Candidate B.

Recruiter 70 may complete recruiter profile query 74 wherein he/she seeks to identify the top 1% of candidates taking T₁ and T₂. In response to recruiter profile query 74, Candidate A may be identified as the preferred candidate for recruiter 70, and as such, candidate profile 62 for Candidate A may be transmitted from recruiter network 72 over a communications network to be displayed to recruiter 70.

It should be appreciated that the candidates as well as the recruiter may provide and receive information from recruiter network 72 through one or more servers 100 as depicted in FIG. 4.

Recruiter network 72 may include a recruiter community that may provide social networking tool to match recruiters to candidates according to embodiments of the present disclosure. As such, recruiters may provide feedback to one another as well as to the operator(s) of recruiter network 72 about various matters including but not limited to the quality of the candidate profiles being transmitted by recruiter network 72, improvements that may be made to recruiter network 72, and recommendations of certain candidates for a job that another recruiter may be offering.

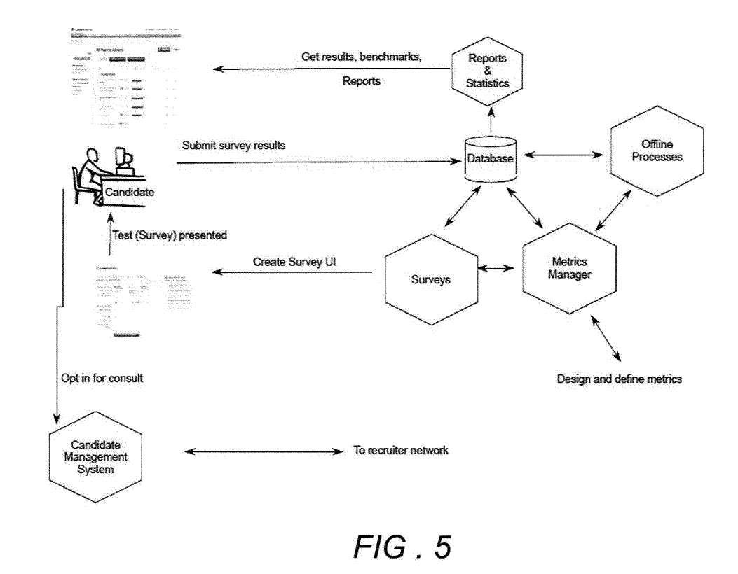

FIG. 5 is a flow chart depicting a system that may combine the candidate benchmarking process with inputs to a recruiter database according to an embodiment of the present disclosure. As depicted in FIG. 5, a candidate may be presented with an aptitude test or survey that may be transmitted from one or more databases residing on one or more servers to be displayed through a survey user interface (UI), such as on a candidate's web browser. When the candidate has completed the aptitude test, the candidate's completed aptitude test may be transmitted back to the one or more databases residing on one or more servers. Using the information provided by the candidate in the aptitude test, benchmark reports and statistics may be generated from the data stored in the one or more databases (including the results of the candidate's aptitude test as well as data compiled from other candidates' aptitude tests to form a population), and the resulting benchmark reports, including any benchmarks, may be provided to the candidate as depicted in FIG. 5. Also, as depicted in FIG. 5, a metrics manager may be in communication with the one or more databases so that as metrics to evaluate candidates are designed and defined, those metrics may be fed to the one or more databases, and then the aptitude tests may be populated with the updated metrics before they are transmitted for completion by new candidates. Other offline processes may also communicate with the metrics manager as well as with the one or more databases as surveys are being developed and modified as depicted in FIG. 5.

In embodiments of the present disclosure, a candidate may elect to participate in follow-up consulting with one or more recruiters associated with the recruiter network. If a candidate is interested in such consulting, the candidate may opt-in for a consult through a candidate management system as depicted in FIG. 5. This may include transmitting a response through a form or other notification mechanism so that the recruiter network may process the requests through one or more servers and identify one or more recruiters that may be interested in providing such a consultation.

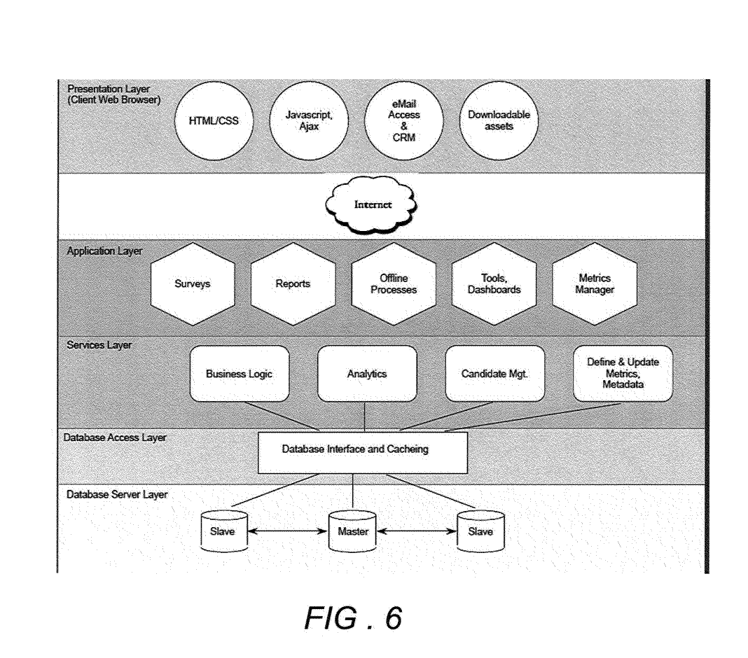

FIG. 6 depicts layers of a system combining the candidate benchmarking process with aspects of a recruiter database according to an embodiment of the present disclosure. In this embodiment of the present disclosure, several layers are depicted with the Internet (or other communication network) being situated as the interface between the presentation layer and the other layers. The presentation layer also may be referred to as the client web browser, and it may operate to provide various items of information to the candidate through various languages and mechanisms for display of information via a browser, including but not limited to hypertext markup language (HTML) and/or cascading style sheets (CSS), Javascript, asynchronous JavaScript (Ajax), email access and customer relationship management (CRM) software, as well as downloadable assets that may be displayed through a candidate's browser. The candidate may interact with the system through the presentation layer according to embodiments of the present disclosure.

The side of the system that may communicate over the Internet to display information via the presentation layer may include several layers, including but not limited to, an application layer, a services layer, a database access layer, and a database server layer according to embodiments of the present disclosure. Each of these layers is depicted in further detail in FIG. 6. It should be appreciated that more or fewer layers may be provided without departing from the present disclosure.

In an embodiment of the present disclosure, the application layer may include surveys, reports, offline processes, tools, dashboards, and a metrics manager. As previously discussed, items such as surveys (such as aptitude tests depicted in FIG. 4) or reports (such as benchmark reports, candidate profiles, and recruiter profiles as depicted in FIG. 4) may be transmitted for display to and use by a candidate. In some embodiments of the present disclosure, an operator of the system may utilize the other items within the application layer to manage the system and adjust the metrics and other items that drive what is provided through surveys and/or reports. It should be appreciated that more or fewer items may be included as part of the application layer without departing from the present disclosure.

The services layer may include business logic/rules, analytics, candidate management, as well as definitions/updates of metrics and metadata according to an embodiment of the present disclosure. Using metrics management tools, a set of metrics for career benchmarking may be produced, and the definition of the metrics may form part of the metadata that may be used in the system according to embodiments of the present disclosure. The metadata may also support a flexible, extensible data model that may be used to store the candidate's profile as well as other data. The metadata, along with other rules and procedures, may be used to produce surveys (or aptitude tests) that are provided for in the application layer according to an embodiment of the present disclosure.

Surveys generated through the recruiter network system may be presented to a candidate in order to collect metrics data that may be relevant to the candidate's career or profession. The survey may be presented to the candidate via his/her web browser, and profile data may be transmitted back to the system via one or more communications networks for storage in one or more databases on one or more servers according to an embodiment of the present disclosure. Metrics data may be processed by online (i.e., in real-time) and/or offline (i.e., via batch processing) systems according to embodiments of the present disclosure. The processed metrics data may then produce one or more analyses that may be provided to the candidate. A candidate may be presented with an offer of career advice that may be delivered via the recruiter network. If the candidate accepts the offer, the candidate may be directed to a recruiter for follow-up. Candidates may be tracked in a contact management system and information from such a system may be dispatched to a recruiter network and then candidates' progress may be tracked through the system according to embodiments of the present disclosure. In the database access layer, there may be a database interface as well as caching according to an embodiment of the present disclosure. This database access layer may provide data and interaction with the services layer as depicted in FIG. 6. The database server layer may include the one or more databases that may store aptitude test data as well as candidate profiles according to embodiments of the present disclosure.

Embodiments of the present disclosure may provide benefits for participating parties including candidates, employers, and recruiters. These benefits may include, but are not limited to, allowing candidates to more accurately represent their career successes and more clearly demonstrate their knowledge, skills, abilities and attributes; allowing recruiters improved access to passive job candidates; allowing recruiter networks to create a pool of candidates before attempting to attract employer clients; allowing recruiter network systems to provide incentives other than employment opportunities; allowing recruiters to quickly identify unqualified candidates using quantitative tools; allowing recruiters to provide candidates with highly personalized insights about candidate opportunities; allowing candidates to compare their career successes directly with their peers in an anonymous environment using benchmarking tools directly associated with their profession; allowing employers to quickly determine the quality of the candidates provided by the recruiter; and allowing employment recruiters to attract highly talented recruits.

Accordingly, besides the objects and advantages of the system for obtaining and evaluating candidates qualifications described above, several objects and advantages of the present disclosure may include, but are not limited to, providing recruiters with all new capabilities in attracting highly-talented candidates; providing incentives beyond just employment opportunities; providing recruiters with access to passive job candidates; providing recruiters with highly-personalized insights about a candidate; providing recruiters with quantitative tools to avoid unqualified candidates; providing recruiters with a pool of candidates before attracting employers; providing recruiters with key metrics not available in existing e-recruitment systems; providing candidates with new capabilities of comparing their career successes directly with their peers in an anonymous environment; providing candidates with tools to demonstrate their knowledge, skills, abilities and attributes using quantitative data; providing employers new tools for measuring their current employees' performance with a pool of candidates; and providing candidates access to a recruiter network to manage their job search.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for recruiting a candidate to a recruiter network over a communications network, the method comprising:
receiving a candidate profession identification from the candidate;
transmitting an aptitude test in response to the candidate profession identification to be displayed via the candidate's browser;
storing the results of the aptitude test in one or more databases residing on the recruiter network;
retrieving a population of candidates associated with the candidate profession identification from the one or more databases;
using at least one processor, comparing the results of the aptitude test to the population to form a candidate profile;
storing the candidate profile in the one or more databases; and
in response to criteria provided by a recruiter, providing one or more candidate profiles to the recruiter.

2. The method of claim 1 further comprising:
evaluating whether the population is sufficient from which to perform the comparing step and generate a benchmark report comparing the candidate against the population of candidates associated with the candidate profession identification.

3. The method of claim 2 further comprising:
providing the benchmark report comparing the candidate against the population of candidates associated with the candidate profession identification.

4. The method of claim 2 further comprising:
via the candidate's browser, displaying a promise to the candidate to provide the benchmark report to the candidate when the population of candidates associated with the candidate profession identification is sufficient from which to perform the comparing step.

5. The method of claim 4 further comprising:
when the benchmark report is displayed to the candidate, displaying a notification to the candidate that the promise has been fulfilled.

6. The method of claim 1 wherein the aptitude test requests the following information:
candidate name and one or more items of information that are specifically associated with the candidate's current profession.

7. The method of claim 1 further comprising:
receiving additional information from the candidate to form part of the candidate profile.

8. A method for recruiting a candidate to a recruiter network over a communications network, the method comprising:
using a browser, providing a candidate profession identification;
in response to providing the candidate profession identification, completing an aptitude test; and
receiving a benchmark report comparing the results of the aptitude test to a population of candidates associated with the candidate profession identification, the benchmark report providing a real time ranking of the candidate relative to the population of candidates associated with the candidate profession identification based on the results of the aptitude test.

9. The method of claim 8 further comprising:
when the population of candidates associated with the candidate profession identification is insufficient to provide a benchmark report to the candidate, receiving a promise to be provided the benchmark report when the population of candidates associated with the candidate profession identification is sufficient from which to provide a real time ranking of the candidate.

10. The method of claim 9 further comprising:
when the benchmark report is displayed following receipt of the promise, receiving a notification that the promise has been fulfilled.

11. The method of claim 8 further comprising:
completing more than one aptitude test, wherein each of aptitude tests is associated with the candidate profession identification.

12. The method of claim 8 wherein the results of the aptitude test become part of the population of candidates associated with the candidate profession identification.

13. A computer-implemented recruiter network, the network comprising:
at least one database that stores aptitude test data received from one or more candidates forming a population of candidates associated with a candidate profession identification; and
at least one processor that compares the aptitude test data received from a candidate against the population of candidates associated with the candidate profession identification to form a candidate profile,
wherein the recruiter network communicates with candidates and recruiters over at least one communication network.

14. The recruiter network of claim 13 wherein the recruiter network communicates with a candidate browser over the at least one communication network.

15. The recruiter network of claim 14 wherein the candidate browser utilizes one or more items selected from the group comprising:
HTML/CSS, Javascript, Ajax, email, CRM, and downloadable assets.

16. The recruiter network of claim 13 further comprising:
a recruiter social networking tool for recruiters and candidates.

17. The recruiter network of claim 13 further comprising:
an application layer containing at least aptitude tests, reports, and a metrics manager.

18. The recruiter network of claim 13 further comprising:
a services layer containing at least candidate management tools, analytics, and business logic, wherein the services layer communicates with a database access layer for database interface and caching.

19. The recruiter network of claim 13 wherein the at least one processor generates a benchmark report that is displayed on the candidate browser, the benchmark report based on the comparison of the candidate's aptitude test data with the population.

20. The recruiter network of claim 13 wherein the at least one processor generates a promise notification that is displayed on the candidate browser when the population of candidates associated with the candidate profession identification is insufficient from which to compare the candidate's aptitude test data.
